(19) United States
(12) Patent Application Publication
(10) Pub. No.: US 2007/0066105 A1
(43) Pub. Date: Mar. 22, 2007

(54) Electrical connector

(75) Inventors: Hiromichi Kato, Koto-ku (JP); Hitoshi Kikuchi, Koto-ku (JP); Yasuyuki Koguchi, Koto-ku (JP); Takahito Haneishi, Koto-ku (JP)

Correspondence Address: BAKER & BOTTS L.L.P., 30 ROCKEFELLER PLAZA, 44TH FLOOR, NEW YORK, NY, 10112-4498, US

(73) Assignee: DDK LTD.

(21) Appl. No.: 11/511,807

(22) Filed: Aug. 29, 2006

(30) Foreign Application Priority Data
Sep. 20, 2005 (JP) 2005-271,336

(51) Int. Cl. H01R 13/62

(52) U.S. Cl. 439/159

(57) ABSTRACT

An electrical connector includes a plurality of contacts, a housing arranging and holding the contacts and having a fitting opening into which a memory card is inserted, and pivotally movable locking members provided at both longitudinal ends of the housing, respectively, for holding and removing the memory card. The housing includes a main body for arranging and holding the contacts, and mounting portions provided at both the longitudinal ends for pivotally movably mounting the locking members. The mounting portions are each provided on both sides in width direction with protruding pieces extending against the inserting direction of the memory card. The locking members each include an anchoring portion adapted to engage and embrace the protruding pieces under a condition the memory card has been inserted. The electrical connector can comply with customers' requirements against vibration and does not cause any failed connection with a memory card even upon vibration and impact.

### BACKGROUND OF THE INVENTION

This invention relates to an electrical connector for use in electronic and electric appliances such as servers, computers and the like, and more particularly to an electrical connector having a construction being stable against vibration and impact.

In exchanging signals (information) between a motherboard and a daughterboard, a plurality of electrical connectors are fixed to the motherboard by soldering or the like, and the daughterboard is inserted into one of the electrical connectors. In other words, the electrical connector each comprises at least a housing having a fitting opening for inserting the daughterboard thereinto, and contacts arranged and held in the housing and extending into the fitting opening.

The applicant of this application has already proposed such electrical connectors in Patent Literature 1 (Japanese Patent Application Opened No. 2002-94,266) and Patent Literature 2 (Japanese Patent Application Opened No. 2005-196,058).

Patent Literature 1

According to ABSTRACT of the Japanese Patent Application Opened No. 2002-94,266, the invention has an object to provide an electrical connector capable of achieving stable electrical connections without unlocking of ejection locks even upon vibration and impact irrespective of weight of substrate. Disclosed is an electrical connector including a required number of contacts, a housing holding and fixing these contacts and having guiding portions at both longitudinal ends and a fitting opening for inserting a substrate thereinto, and ejection locks pivotally movably mounted on the guiding portions, wherein lock-protecting members are mounted on the guiding portions for preventing engaging portions of the ejection locks from disengaging from anchoring portions of the substrate when the substrate has been inserted into the fitting opening, and wherein when the lock-protecting members are slidably moving, the lock-protecting members can be guided by means of both guiding protrusions.

In connection with the above description, claim 1 of the Patent Literature 1 recites an electrical connector including a required number of contacts; a housing holding and fixing said contacts and having guiding portions at both longitudinal ends and a fitting opening for inserting a substrate thereinto; and ejection locks pivotally movably mounted on said guiding portions, wherein lock-protecting members are mounted on said guiding portions for preventing engaging portions of said ejection locks from disengaging from anchoring portions of said substrate when it has been inserted into said fitting opening. Claim 2 recites that in the electrical connector as set forth in claim 1, said lock-protecting members are slidably mounted in the thickness direction of said electrical connector. Claim 3 recites that in the electrical connector as set forth in claim 1, said ejection locks are provided with anchoring grooves on both sides in the width direction and said lock-protecting members are provided with engaging projections on inner sides in the width direction so that when said substrate has been inserted to engage said ejection locks, said engaging projections of the lock-protecting members engage said anchoring grooves of said ejection locks. Claim 4 recites that in the electrical connector as set forth in claim 2, said lock-protecting members are provided with guiding protrusions A and B on both their left and right sides so that when said lock-protecting members are slidably moved, said lock-protecting members are guided by both said guiding protrusions. Claim 5 recites that in the electrical connector as set forth in claim 4, said lock-protecting members are provided with protrusions at positions shifted in the inserting direction of said substrate from said guiding protrusions B, so that the holding for said ejection locks in their pivotally moving direction is reinforced by means of said protrusions.

Patent Literature 2

According to the ABSTRACT of the Japanese Patent Application Opened No. 2005-196,058, the invention has an object to provide an electrical connector 10 permitting a soldering iron to be inserted into spacing between electrical connectors arranged even with a pitch of 6 mm to 8 mm in width direction without causing the soldering iron to contact any housing 12 during soldering. Disclosed is an electrical connector for a memory card 60 to be removably inserted thereinto, including plurality of contacts 14 each having a contact portion 28 adapted to contact a memory card 60, a housing 12 arranging and holding the contacts 14 and having a fitting opening 18 for inserting the memory card 60, and pivotally movable locking members 16 provided on both longitudinal ends of the housing 12 for holding and removing the memory card 60 onto and from the housing, wherein in the case that the electrical connectors are arranged in parallel with one another in their width directions with a pitch of 6.0 to 8.0 mm, the housing 12 is provided with reliefs on its upper side on both sides in its width direction for a soldering iron and provided with recesses 22 on its lower side on both sides in the width direction.

In connection with the above description, claim 1 of the Japanese Patent Application Opened No. 2005-196,058 recites an electrical connector for a memory card to be removably inserted thereinto, including a plurality of contacts each having a contact portion adapted to contact said memory card, a housing arranging and fixing said contacts and having a fitting opening for inserting said memory card, and pivotally movable locking members provided on both longitudinal ends of said housing for holding or removing said memory card onto or from the housing, wherein in the case that said electrical connectors are arranged in parallel with one another in their width directions with a pitch of 6.0 to 8.0 mm, said housing is provided with reliefs on its upper side on both sides in its width direction for a soldering iron and provided with recesses on its lower side on both sides in the width direction. Claim 2 recites that in the electrical connector as set forth in claim 1, said reliefs are outwardly inclined slopes. Claim 3 recites that the electrical connector as set forth in claim 1 or 2, longitudinal sizes of said slopes and said recesses are just as long as or longer than longitudinally extending pitches of said contacts. Claim 4 recites that the electrical connector as set forth in claim 1, 2, or 3, said locking members are each provided with substantially trapezoid protrusions extending 0.1 to 0.5 mm in the width direction.

In recent years, amounts of information to be exchanged have been greatly increased, with the result that great many connectors are increasingly being used. On the other hand, the trend in information appliances has been toward increasingly smaller geometries so that substrates have also been miniaturized. Moreover, according to the current standard of memory cards, performance against vibration up to 55 Hz is required. However, performance withstanding vibrations up to 500 Hz, even as high as 2,000 Hz is required depending upon customers, particularly manufacturers of the servers.

Nevertheless, the constructions disclosed in the above Patent Literatures 1 and 2 could not comply with such requirements of performance against vibration (Standard: EIA-364-28) and would exhibit low resistance to vibration and impact, causing defective or failed connection. Such problems would remain to be solved. In other words, even if size of the fitting opening of the housing and width dimension of guiding portions may be designed in consideration of the tolerance of thickness of the memory card, clearances would become larger, resulting in low resistance to vibration and impact. (For example, even if dimensions of the memory card and the housing are nominal values, clearances would become large).

### SUMMARY OF THE INVENTION

In view of the problems of the prior art, it is an object of the invention to provide an electrical connector which can comply with customers' requirements of performance against vibration and which does not cause any failed connection with a memory card even if being subjected to vibration and impact.

The above object can be achieved by an electrical connector 10 for a memory card 60 to be removably inserted thereinto, including a plurality of contacts 14 each having a contact portion adapted to contact said memory card 60, a housing 12 arranging and holding said contacts 14 therein and having a fitting opening 28 into which said memory card 60 is inserted, and pivotally movable locking members 16 provided at both longitudinal ends of the housing 12, respectively, for holding and removing said memory card 60 onto and from the housing, wherein according to the invention said housing 12 comprises a main body 18 for arranging and holding said contacts 14, and mounting portions 20 provided at both the longitudinal ends for pivotally movably mounting thereon said locking members 16, said mounting portions 20 of said housing 12 being each provided on both sides in width direction with protruding pieces 22 extending against the inserting direction of said memory card 60, and said locking members 16 each comprise an anchoring portion 38 adapted to engage and embrace said protruding pieces 22 under a condition that said memory card 60 has been inserted.

Under a condition that said memory card 60 has been inserted into said electrical connector and locked by said locking members 16, said anchoring portions 38 of said locking members 16 cause said protruding pieces 22 of the housing 12 to be deformed inwardly toward each other so that said memory card is embraced by substrate guides 24 so as to be pinched therebetween.

Said protruding pieces 22 are each provided at a tip with a guide portion 32. Moreover, a size of said anchoring portions 38 is 0.1 mm to 0.4 mm smaller than the distance between outer surfaces of said protruding pieces 22, and said substrate guides 24 have elasticity.

The electrical connector according to the invention exhibits the following function. After the memory card 60 has been inserted into the electrical connector, the locking members 16 are pivotally moved to receive the protruding pieces 22 of the housing 12 into the anchoring portions 38 of the locking members 16, respectively, so that the protruding pieces 22 are deformed inwardly toward each other to embrace the memory card between the substrate guides 24 of the housing.

As can be seen from the above description, the electrical connector 10 according to the invention can bring about the following significant effects. (1) In the electrical connector 10 for a memory card 60 to be removably inserted thereinto, including a plurality of contacts 14 each having a contact portion adapted to contact said memory card 60, a housing 12 arranging and holding said contacts 14 therein and having a fitting opening 28 into which said memory card 60 is inserted, and pivotally movable locking members 16 provided at both longitudinal ends of the housing 12, respectively, for holding and removing said memory card 60 onto and from the housing, according to the invention said housing 12 comprises a main body 18 for arranging and holding said contacts 14, and mounting portions 20 provided at both the longitudinal ends for pivotally movably mounting thereon said locking members 16, said mounting portions 20 of said housing 12 being each provided on both sides in width direction with protruding pieces 22 extending against the inserting direction of said memory card 60, and said locking members 16 each comprise an anchoring portion 38 adapted to engage and embrace said protruding pieces 22 under a condition that said memory card 60 has been inserted. Therefore, the electrical connector according to the invention can withstand vibration of up to 500 Hz, even as high as 2,000 Hz to comply with customers' requirements and there is no defective connection with a memory card due to vibration and impact so that stable connection can be obtained.

(2) According to the invention, under a condition that said memory card 60 has been inserted into said electrical connector and locked by said locking members 16, said anchoring portions 38 of said locking members 16 cause said protruding pieces 22 of the housing 12 to be deformed inwardly toward each other so that said memory card is embraced by substrate guides 24 so as to be pinched therebetween. Consequently, the electrical connector according to the invention can be securely connected to a memory card 60 and withstand vibration of up to 500 Hz, even as high as 2,000 Hz to comply with customers' requirements so that no defective connection with a memory card occurs due to vibration and impact.

(3) According to the invention, said protruding pieces 22 are each provided at a tip with a guide portion 32. Therefore, when the locking members 16 are pivotally moved, the anchoring portions 38 of the locking members 16 can be easily engaged with the protruding pieces 22 of the housing 12 without damaging the protruding pieces 22, thereby causing the protruding pieces 22 of the housing 12 to embrace the memory card securely.

(4) According to the invention, a size of said anchoring portions 38 is 0.1 mm to 0.4 mm smaller than the distance between outer surfaces of said protruding pieces 22, and said substrate guides 24 have elasticity. Consequently, the electrical connector according to the invention can be securely connected to a memory card 60 and withstand vibration of up to 500 Hz, even as high as 2,000 Hz to comply with customers' requirements so that no defective connection with a memory card occurs due to vibration and impact and hence stable connection can be obtained.

The invention will be more fully understood by referring to the following detailed specification and claims taken in connection with the appended drawings.

### BRIEF DESCRIPTION OF THE DRAWINGS

FIG. 1A is a perspective view of a memory card and an electrical connector according to the invention viewed from its fitting opening side;

FIG. 1B is a perspective view of the electrical connector with a memory card inserted, viewed from the fitting opening side;

FIG. 2A is a partly enlarged perspective view of the proximity of the locking member of the electrical connector not having the memory card to be inserted; and

FIG. 2B is a partly enlarged perspective view of the proximity of the locking member of the electrical connector with the memory card inserted.

### DESCRIPTION OF THE PREFERRED EMBODIMENTS

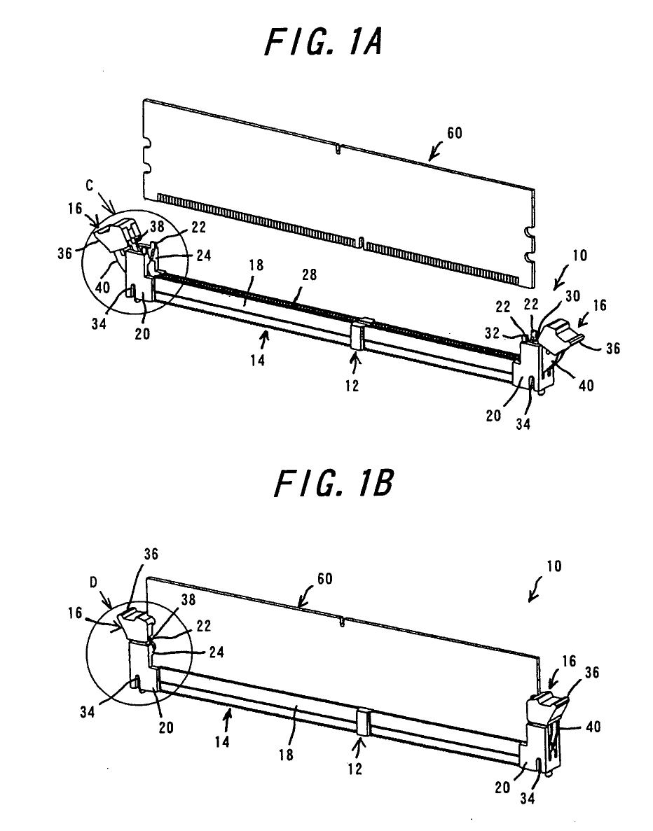

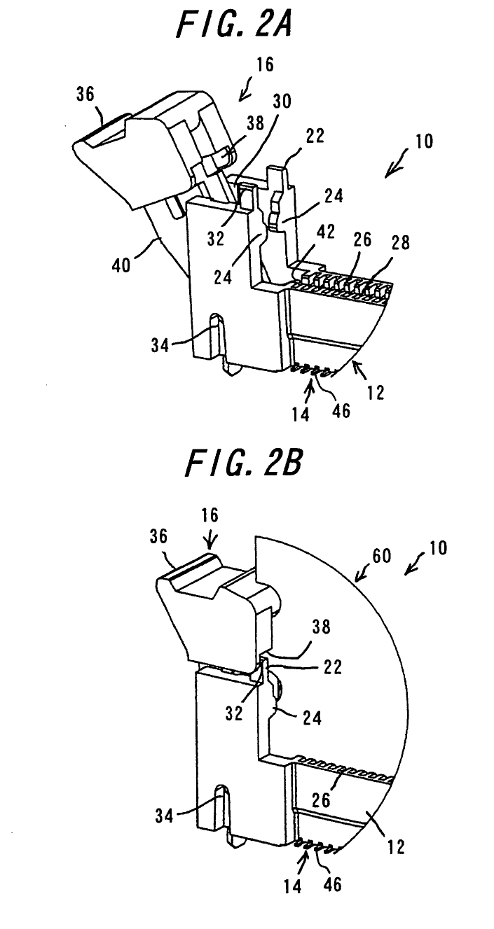

One embodiment of the electrical connector according to the invention will be explained with reference to FIGS. 1A to 2B. FIG. 1A is a perspective view of a memory card and the electrical connector according to the invention viewed from the fitting opening side, and FIG. 1B is a perspective view of the electrical connector according to the invention with the memory card inserted, viewed from the fitting opening side. FIG. 2A is a partly enlarged perspective view of the proximity of a locking member of the electrical connector into which the memory card has not been inserted, while FIG. 2B is a partly enlarged perspective view of the proximity of the locking member of the electrical connector with the memory card inserted.

The electrical connector 10 according to the invention mainly comprises a plurality of contacts 14, a housing 12, and locking members 16.

Before explaining the components of the electrical connector, the memory card (daughterboard) 60 will be explained. Said memory card 60 is used in personal computers, servers, printers and the like, and mainly comprises contact portions to be brought into contact with contact portions of contacts 14, patterns connected from said contact portions of the memory card to circuits, and connection portions connecting to ICs and CPUs mounted on said patterns. The memory cards 60 for use in the electrical connector 10 according to the invention include DDR2 card, DIMM memory card, FB-DIMM card, SO-DIMM memory card, exclusive memory cards and the like. The FB-DIMM card is used for the electrical connector in the illustrated embodiment.

First, the housing 12 will be explained, which is one subject feature of the invention. The housing 12 is formed from an electrically insulating plastic material by means of the injection molding of the known technique. The material may be suitably selected in consideration of dimensional stability, workability, manufacturing cost and the like and, in general, suitable materials for the housing 12 include polybutylene terephthalate (PBT), polyamide (66PA or 46PA), liquid crystal polymer (LCP), polycarbonate (PC) and the like and combination thereof. Said housing 12 may be roughly divided into two parts, that is, a main body 18 arranging and holding the contacts 14 and having a fitting opening 28 into which said memory card 60 is inserted, and mounting portions 20 each on which a locking member 16 is pivotally mounted. Each of the mounting portions 20 extends from the main body 18 toward the memory card 60 positioned to be inserted into the electrical connector 10, and is provided with an inserting opening 30 into which said locking member 16 is inserted and mounted. The size of said fitting opening 28 may be suitably designed so that a required number of memory cards 60 can be inserted into the fitting opening and the memory card can contact the two opposite contacts 14 when it has been inserted into the housing. The size of the inserting openings 30 may be suitably designed such that the locking members 16 can be inserted so as to be pivotally movable, respectively.

Each of said inserting openings 30 of the housing 12 is of substantially U-shape having two side walls which are symmetrically positioned taking into consideration of said memory card 60. The bottom portion of the two side walls is formed with a bearing portion 34 in which a shaft of the locking member 16 is fitted. The size, position, and shape of the bearing portion 34 may be suitably designed so that the locking member 16 is pivotally movable, and upon pivotal movement of the locking member 16, said memory card 60 is pushed upwardly to be removed from the housing.

Said side walls are each provided with a substrate guide 24 so that the two substrate guides 24 extend inwardly of the inserting opening 30 and face to each other. Said memory card 60 is held and embraced by the two substrate guides 24 facing to each other. The distance between the two substrate guides 24 facing to each other may be suitably designed in consideration of a thickness and tolerance of the memory card 60, a holding force for the memory card 60, strength of the substrate guides 24 and the like. The substrate guide 24 is of a two-step shape so as to facilitate the insertion of the memory card 60 and so as not to cause any damage to the memory card 60. The portion of the substrate guide 24 for embracing the memory card 60 is rounded to avoid the memory card from being scratched. As the memory card 60 to be inserted into the electrical connector in the illustrated embodiment is 1.27 mm in thickness and its tolerance is ±0.1 mm, the distance between the substrate guides 24 facing to each other is 1.40 mm. Although it is difficult to obtain a sufficient holding force for the memory card due to the tolerance, the memory card embraced by the substrate guides 24 becomes stable against vibration owing to the functions described above to sufficiently comply with customers' requirements. In the illustrated embodiment, the substrate guides 24 are made to be somewhat elastic.

Each of the two opposite side walls is provided with a protruding piece 22 at its top so that the two protruding pieces 22 extend against the inserting direction of the memory card 60. The two protruding pieces 22 facing to each other serve as the following manner. When the memory card 60 has been inserted into the housing and the locking members 16 are pivotally moved, the protruding pieces 22 enter an anchoring portion 38 described later of each of the locking members 16 to push the protruding pieces 22 inwardly toward each other so that the substrate guides 24 of the housing 12 move toward each other to embrace the memory card therebetween. The size, shape and positions of the protruding pieces 22 may be suitably designed in consideration of such functions, strength of the protruding pieces 22, miniaturization of the electrical connector, and the like. Each of the protruding pieces 22 is provided with a guide portion 32 at the outer side of its top portion so that the anchoring portion 38 of the locking member 16 readily engages the protruding piece 22.

The main body 18 of the housing 12 is provided with inserting holes 26 for inserting said contacts 14, and a fitting opening 28 for inserting said memory card 60.

The inserting holes 26 serve to arrange and hold the contacts 14, respectively. The size of the inserting holes 26 may be suitably designed such that the contacts 14 can be held in the inserting holes 26 and the contact portions of said contacts 14 extend into the fitting opening 28 so as to contact the memory card 60 with a substantially constant contact pressure. Said fitting opening 28 is for inserting said memory card 60. The size of the fitting opening 28 may be suitably designed depending upon kinds and sizes of memory cards 60 to be inserted thereinto.

The locking members 16 will now be explained. The locking members 16 are formed from an electrically insulating plastic material by means of the injection molding of the known technique similarly to the housing 12. The material for the locking members 16 may be suitably selected in consideration of dimensional stability, workability, manufacturing cost and the like and, in general, the materials suitable for the locking members 16 include polybutylene terephthalate (PBT), polyamide (66PA or 46PA), liquid crystal polymer (LCP), polycarbonate (PC) and the like and combination thereof.

The locking members 16 are for removing the memory card 60 from the electrical connector, and are arranged at both the longitudinal ends of the housing 20, respectively. A single locking member 16 may be arranged on either of the longitudinal ends of the housing. In the illustrated embodiment, the locking members are arranged at the both sides, respectively, in consideration of the stability and balancing of the held memory card 60. Said locking members 16 each comprise an actuating portion 36, a pushing-up portion 42 for pushing the memory card 60 upwardly, and an intermediate portion 40 for connecting the actuating portion 36 and the pushing-up portion 42.

The actuating portion 36 of the locking member 16 is provided on its lower surface with the anchoring portion 38 adapted to engage the protruding pieces 22 of said housing 12. The anchoring portion 38 is in the form of a recess in the illustrated embodiment. Position of the anchoring portion 38 may be suitably designed so that upon insertion of the memory card 60, the protruding pieces 22 are accommodated in the anchoring portion 38. The size of the anchoring portion 38 is 0.1 mm to 0.4 mm smaller than the distance between the outer surfaces of the two protruding pieces 22 so that the anchoring portion 38 engages the protruding pieces 22 to push the substrate guides 24 inwardly toward each other, thereby securely embracing the memory card 60 by said substrate guides 24. If the dimensional difference of the anchoring portion 38 from that distance between the two protruding pieces 22 such as 0.1 mm to 0.4 mm becomes smaller, it will be impossible to comply with the customer's requirement of stability against vibration and to embrace the memory card 60 securely. If the above dimensional difference is more than 0.4 mm, there is a risk of the memory card 60 and the protruding pieces 22 being damaged.

The pushing-up portion 42 is so shaped as to embrace the memory card 60 and contact the bottom of the memory card 60. The shape of the pushing-up portion 42 may be suitably designed so as to be able to push the memory card upwardly and in consideration of the strength and the like of the locking member 16. The size, position and shape of said shaft of the locking member 16 may be suitably designed so that the shaft is snugly fitted in the bearing portion 34 of said housing 12 and the locking member 16 can be pivotally moved to remove said memory card 60.

Finally, a plurality of the contacts 14 will be explained. The contacts 14 are made of a metal and formed by means of the press-working of the known technique. Preferred metals from which to form the contacts 14 include brass, beryllium copper, phosphor bronze and the like which comply with the requirements such as springiness, electric conductivity, dimensional stability and the like.

Said contacts 14 each comprise at least the contact portion adapted to contact said memory card 60, a fixed portion to be fixed to said housing 12, and a connection portion 46 to be connected to a substrate. Said contact portion is formed in a curved shape to facilitate contacting of the contact portion with the memory card 60. The connection portion 46 of the contact 14 is of a surface mounting type (SMT) in consideration of design of circuits on the substrate in the illustrated embodiment, it may be of a dip type. Said contacts 14 are arranged in parallel with one another so that said contact portions face to each other to embrace said memory card 60 between the opposite contacts 14. Said contacts 14 are fixed to said housing 12 by means of press-fitting, holing (lancing), welding and the like.

Examples of applications of the electrical connector are electrical connectors 10 for use in electronic and electric appliances such as servers, computers and the like, and more particularly electrical connectors having a construction being stable against vibration and impact.

While the invention has been particularly shown and described with reference to the preferred embodiments thereof, it will be understood by those skilled in the art that the foregoing and other changes in form and details can be made therein without departing from the spirit and scope of the invention.

What is claimed is:

1. An electrical connector for a memory card to be removably inserted thereinto, including a plurality of contacts each having a contact portion adapted to contact said memory card, a housing arranging and holding said contacts therein and having a fitting opening into which said memory card is inserted, and pivotally movable locking members provided at both longitudinal ends of the housing, respectively, for holding and removing said memory card into and from the housing,
wherein said housing is provided with a main body for arranging and holding said contacts, and mounting portions provided at both the longitudinal ends for pivotally movably mounting thereon said locking members, said mounting portions of said housing being each provided on both sides in width direction with protruding pieces extending against the inserting direction of said memory card, and said locking members each having an anchoring portion adapted to engage and embrace said protruding pieces under a condition that said memory card has been inserted.

2. The electrical connector as set forth in claim 1, wherein under a condition that said memory card has been inserted into said electrical connector and locked by said locking members, said anchoring portions of said locking members cause said protruding pieces of the housing to be deformed inwardly toward each other so that said memory card is embraced by substrate guides so as to be pinched therebetween.

3. The electrical connector as set forth in claim 1, wherein said protruding pieces are each provided at a tip with a guide portion.

4. The electrical connector as set forth in claim 1, wherein a size of said anchoring portions is 0.1 mm to 0.4 mm smaller than a distance between outer surfaces of said protruding pieces, and said substrate guides have elasticity.

5. The electrical connector as set forth in claim 3, wherein a size of said anchoring portions is 0.1 mm to 0.4 mm smaller than a distance between outer surfaces of said protruding pieces, and said substrate guides have elasticity.

6. The electrical connector as set forth in claim 1, wherein said protruding pieces are each provided at a tip with a guide portion.

7. The electrical connector as set forth in claim 2, wherein a size of said anchoring portions is 0.1 mm to 0.4 mm smaller than a distance between outer surfaces of said protruding pieces, and said substrate guides have elasticity.

8. The electrical connector as set forth in claim 6, wherein a size of said anchoring portions is 0.1 mm to 0.4 mm smaller than a distance between outer surfaces of said protruding pieces, and said substrate guides have elasticity.
